(19) United States
(12) Patent Application Publication
(10) Pub. No.: US 2018/0079099 A1
(43) Pub. Date: Mar. 22, 2018

(54) CUTTING APPARATUS AND NON-TRANSITORY RECORDING MEDIUM FOR STORING CUTTING DATA GENARATING PROGRAM

(71) Applicant: BROTHER KOGYO KABUSHIKI KAISHA, Nagoya (JP)

(72) Inventor: Satomi Yamamoto, Aichi (JP)

(21) Appl. No.: 15/829,005

(22) Filed: Dec. 1, 2017

Related U.S. Application Data
(63) Continuation of application No. PCT/JP2016/066161, filed on Jun. 1, 2016.

(30) Foreign Application Priority Data
Jun. 3, 2015 (JP) 2015-113072

(51) Int. Cl. B26D 5/00

(52) U.S. Cl. CPC B26D 5/005

(57) ABSTRACT

A cutting apparatus comprising: a cutting mechanism configured to cut an object to be cut based on cutting data; and a controller configured to: specify a plurality of patterns; acquire attribute information representing an attribute of the specified patterns; classify the respective patterns into two or more groups based on the acquired attribute information; generate the cutting data in which the patterns are arranged for each of the classified groups; and control the cutting mechanism to cut the patterns based on the generated cutting data.

### CROSS-REFERENCE TO RELATED APPLICATION

This application is a continuation application of International Application No. PCT/JP2016/066161, filed on Jun. 1, 2016, which claims priority from Japanese Patent Application No. 2015-113072, filed on Jun. 3, 2015. The disclosure of the foregoing application is hereby incorporated by reference in its entirety.

### FIELD

The present disclosure relates to a cutting apparatus that cuts a sheet-like object to be cut and a non-transitory recording medium for storing a cutting data generating program for generating cutting data used for the cutting apparatus.

### BACKGROUND

Cutting apparatuses are conventionally known which automatically cut sheet-like paper or the like, which is an object to be cut, into a user-desired pattern or shape. The cutting apparatus is provided with a holding member and the object to be cut is placed on the holding member. The cutting apparatus generates cutting data from the user-desired pattern or shape and cuts the object to be cut on the holding member based on the cutting data.

Such a cutting apparatus may be provided with the following function. When cutting a plurality of patterns by a single cutting operation, the function generates cutting data by automatically arranging the respective patterns at appropriate positions on the holding member. In this case, the appropriate positions on the holding member are such positions as to minimize distances between the respective patterns.

### SUMMARY

However, when a plurality of patterns with different attributes such as color are used as objects to be cut, if the above automatic arrangement is performed, a plurality of patterns with different attributes are arranged mixed together, that is, with the patterns with the respective attributes mingling with each other. In this case, the user needs to arrange the object to be cut corresponding to the attribute of each pattern on the holding member in accordance with the position at which each pattern is cut, and such an operation is quite complicated.

The present disclosure has been implemented in view of the above circumstances and it is an object of the present disclosure to provide a cutting apparatus that allows, when patterns to be cut are a mixture of a plurality of patterns with different attributes, a user to easily arrange each object to be cut on a holding member and a non-transitory recording medium for storing a cutting data generating program.

In order to attain the above object, a cutting apparatus comprising: a cutting mechanism configured to cut an object to be cut based on cutting data; and a controller configured to: specify a plurality of patterns; acquire attribute information representing an attribute of the specified patterns; classify the respective patterns into two or more groups based on the acquired attribute information; generate the cutting data in which the patterns are arranged for each of the classified groups; and control the cutting mechanism to cut the patterns based on the generated cutting data.

This summary is not intended to identify critical or essential features of the disclosure, but instead merely summarizes certain features and variations thereof. Other details and features will be described in the sections that follow.

### BRIEF DESCRIPTION OF DRAWINGS

Aspects of the disclosure are illustrated by way of example, and not by limitation, in the accompanying figures in which like reference characters may indicate similar elements.

FIG. 1 is a perspective view illustrating a cutting apparatus according to an embodiment;

FIG. 2 is a block diagram illustrating an electrical configuration of the cutting apparatus;

FIG. 3 is a diagram illustrating attribute information with which a pattern is provided;

FIG. 4 is a flowchart illustrating a processing flow of a whole cutting data generating program;

FIG. 5 is a flowchart illustrating an intra-group arrangement process;

FIG. 6 is a flowchart illustrating an on-sheet arrangement process (No. 1);

FIG. 7 is a flowchart illustrating an on-sheet arrangement process (No. 2);

FIG. 8 is a diagram illustrating an example of display contents displayed on a display in a specification process;

FIG. 9 is a diagram illustrating a concept of a classification process;

FIG. 10 is a diagram illustrating a concept of an intra-group arrangement process;

FIG. 11 is a diagram illustrating a concept when calculating a minimum enclosing rectangle through a calculation process;

FIG. 12 is a diagram illustrating a concept when arranging respective patterns in four corners of an allowable cutting range;

FIG. 13 is a diagram illustrating an example of display contents displayed on a display through a notification process;

FIG. 14 is a diagram illustrating an example of display contents displayed on a display through a specification process;

FIG. 15 is a diagram illustrating a concept of a classification process;

FIG. 16 is a diagram illustrating a concept when calculating an enlarged enclosing rectangle through a calculation process;

FIG. 17 is a diagram illustrating a concept when arranging each pattern within an allowable cutting range;

FIG. 18 is a diagram illustrating an example of display contents displayed on a display through a notification process; and

FIG. 19 is a diagram illustrating a distance relationship among respective patterns.

### DETAILED DESCRIPTION

For a more complete understanding of the present disclosure, needs satisfied thereby, and the objects, features, and advantages thereof, reference now is made to the following descriptions taken in connection with the accompanying drawings. Hereinafter, illustrative embodiments will be described with reference to the accompanying drawings.

Hereinafter, a cutting apparatus and a cutting data generating program according to an embodiment will be described with reference to the accompanying drawings.

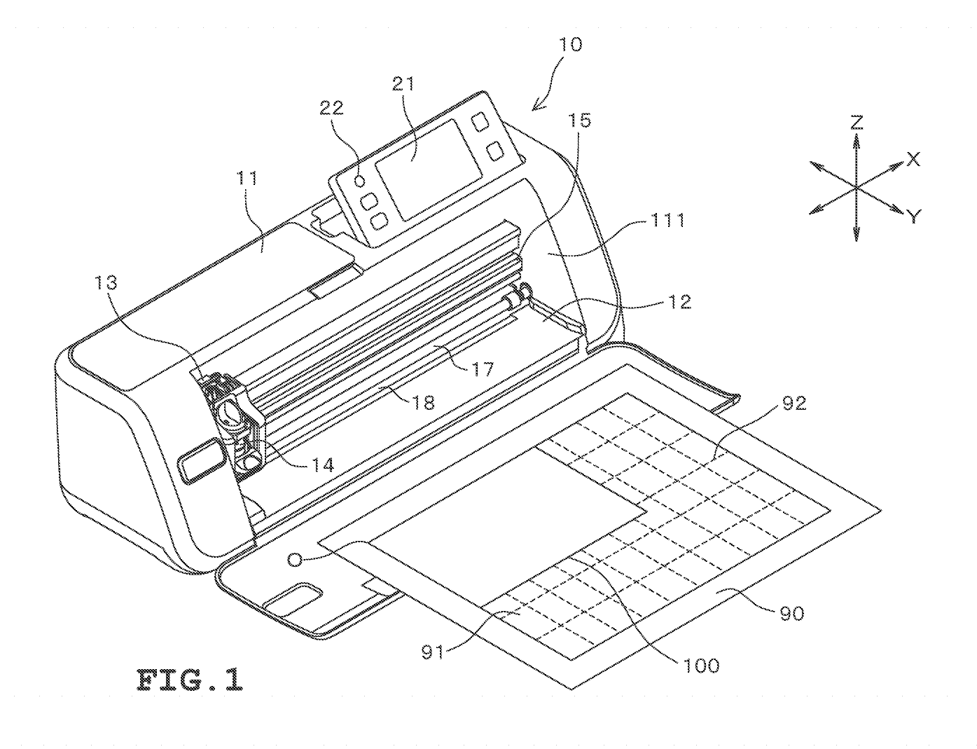

A cutting apparatus 10 shown in FIG. 1 is intended to cut an object to be cut 100 held by a holding member 90 into a desired shape. The cutting apparatus 10 is provided with a body cover 11, a platen 12, a carriage 13 and a cutter cartridge 14. The platen 12 is provided inside the body cover 11 and formed into a substantially horizontal flat plate shape. The cutter cartridge 14 is detachably attached to the carriage 13. Though details are not shown, a cutter provided with a blade at its distal end is attached to the cutter cartridge 14 in an interchangeable manner.

The body cover 11 constitutes a housing of the cutting apparatus 10. The body cover 11 includes an opening 111 and is formed into a rectangular box shape as a whole. The body cover 11 covers the whole outside of the platen 12, the carriage 13 and the cutter cartridge 14. In the following description, the opening 111 side with respect to the body cover 11 is assumed to be the front side of the cutting apparatus 10. A front-back direction on the platen 12 in which the holding member 90 is transferred is assumed to be a Y-direction and a left-right direction orthogonal to the Y-direction is assumed to be an X-direction. An up-down direction orthogonal to the platen 12 is assumed to be a Z-direction.

The holding member 90 is formed into a rectangular flat plate shape and includes an adhesive layer on its front surface. The holding member 90 holds the object to be cut 100 pasted to the adhesive layer and is placed on the platen 12. An allowable cutting range 91 is set on the holding member 90. The allowable cutting range 91 has a rectangular shape one size smaller than the outside shape of the holding member 90. The cutting apparatus 10 can cut the object to be cut 100 placed within the allowable cutting range 91. A plurality of ruler lines extending in the X-direction and the Y-direction crossing each other are provided at equal intervals. A plurality of squares 92 are formed of the plurality of ruler lines at equal intervals.

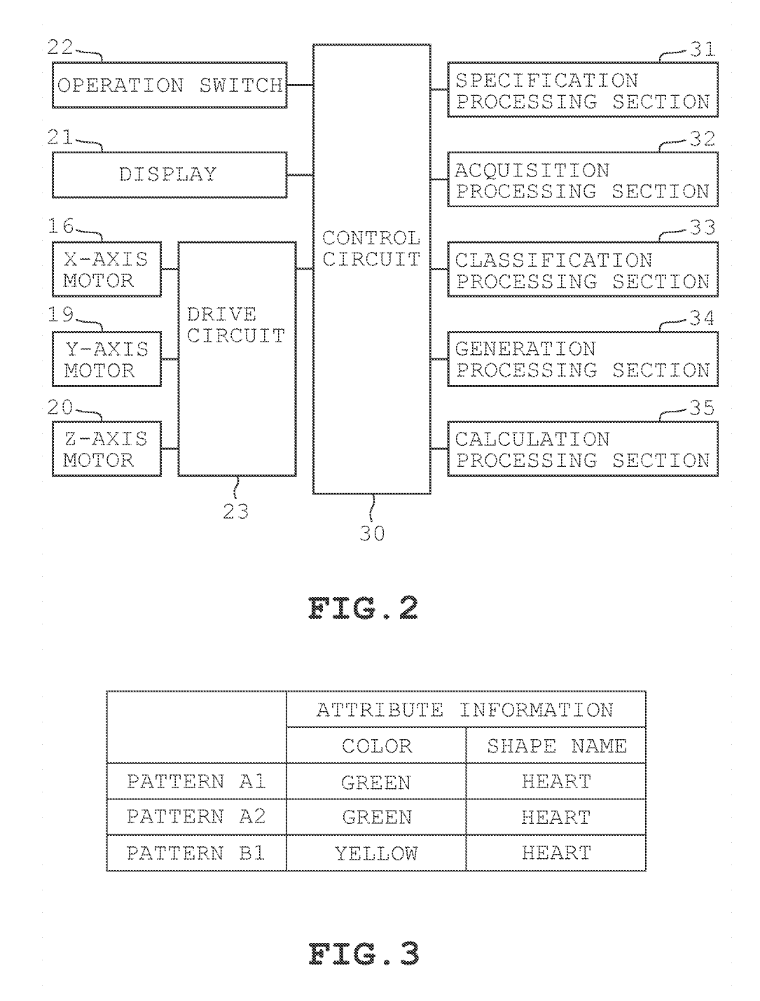

The cutting apparatus 10 is provided with an X-axis moving mechanism, a Y-axis moving mechanism and a Z-axis moving mechanism. The X-axis moving mechanism, the Y-axis moving mechanism and the Z-axis moving mechanism constitute a cutting mechanism for cutting the object to be cut 100 placed on the holding member 90. The X-axis moving mechanism is configured by including an X-axis guide rail 15 shown in FIG. 1 and an X-axis motor 16 shown in FIG. 2, or the like. The X-axis guide rail 15 is provided in a mechanical frame (not shown) in the body cover 11 and extends in the X-direction. The X-axis motor 16 is provided in the body cover 11. As the X-axis motor 16 rotates, the X-axis moving mechanism causes the carriage 13 to move in the X-direction along the X-axis guide rail 15.

The Y-axis moving mechanism is configured by including a drive roller 17 and a pinch roller 18 shown in FIG. 1, and a Y-axis motor 19 shown in FIG. 2. The drive roller 17 and the pinch roller 18 are attached to a mechanical frame (not shown) in the body cover 11 and extend in the X-direction. The drive roller 17 and the pinch roller 18 sandwich both end portions of the holding member 90 set on the platen 12 from above and below. The Y-axis motor 19 is provided in the body cover 11. The Y-axis moving mechanism transmits the rotary motion of the Y-axis motor 19 to the drive roller 17, and thereby causes the holding member 90 to move in the Y-direction.

The Z-axis moving mechanism is configured by including a Z-axis motor 20 shown in FIG. 2. The Z-axis motor 20 is provided in the carriage 13. As the Z-axis motor 20 rotates, the Z-axis moving mechanism causes the cutter cartridge 14 to move in the up-down direction, that is, in the Z-direction.

In this configuration, if the cutter cartridge 14 is moved downward by the Z-axis moving mechanism, a distal end portion of the cutter attached to the cutter cartridge 14 bites into the object to be cut 100 held by the holding member 90. With the distal end portion of the cutter bitten in the object to be cut 100, the cutting apparatus 10 causes the carriage 13 to move in the X-direction through the X-axis moving mechanism, also causes the object to be cut 100 to move in the Y-direction through the Y-axis moving mechanism, and thereby cuts the object to be cut 100 into a desired shape.

Note that the cutting apparatus 10 sets an XY coordinate system with a left corner of the allowable cutting range 91 of the holding member 90 shown in FIG. 1 as an origin O, and the holding member 90 and the cutter cartridge 14 relatively move based on the XY coordinate system.

As shown in FIG. 1 and FIG. 2, the cutting apparatus 10 is provided with a display 21 and various operation switches 22. The display 21 is, for example, a color liquid crystal display and displays necessary messages or the like for the user. The user makes various settings and confirms an operation situation by operating the various operation switches 22. Note that the display 21 may be a touch type liquid crystal display having an input function.

As shown in FIG. 2, the cutting apparatus 10 is provided with a control circuit 30. The control circuit 30 is constructed of a microcomputer as a main constituent, which includes a CPU, a ROM, a RAM and a storage region such as a rewritable flash memory (all of which are not shown) and which controls the whole cutting apparatus 10. The display 21 and the various operation switches 22 are connected to the control circuit 30. The X-axis motor 16, the Y-axis motor 19 and the Z-axis motor 20 are connected to the control circuit 30 via the drive circuit 23.

The ROM of the control circuit 30 stores control programs such as a cutting data generating program and an operation program. The RAM of the control circuit 30 stores cutting data or the like to drive each motor 16, 19 or 20 and cut the object to be cut 100 into a desired shape. The cutting apparatus 10 can generate cutting data for itself by executing the cutting data generating program. The cutting apparatus 10 can also acquire cutting data generated by another computer via, for example, the Internet and a detachable non-transitory recording medium.

The control circuit 30 causes the CPU to execute the cutting data generating program stored in the ROM and thereby virtually implements a specification processing section 31, an acquisition processing section 32, a classification processing section 33, a generation processing section 34, and a calculation processing section 35 or the like by software. Note that these respective processing sections 31 to 35 may be implemented by hardware, for example, as an integrated circuit integral with the control circuit 30 or may be implemented through collaboration between hardware and software.

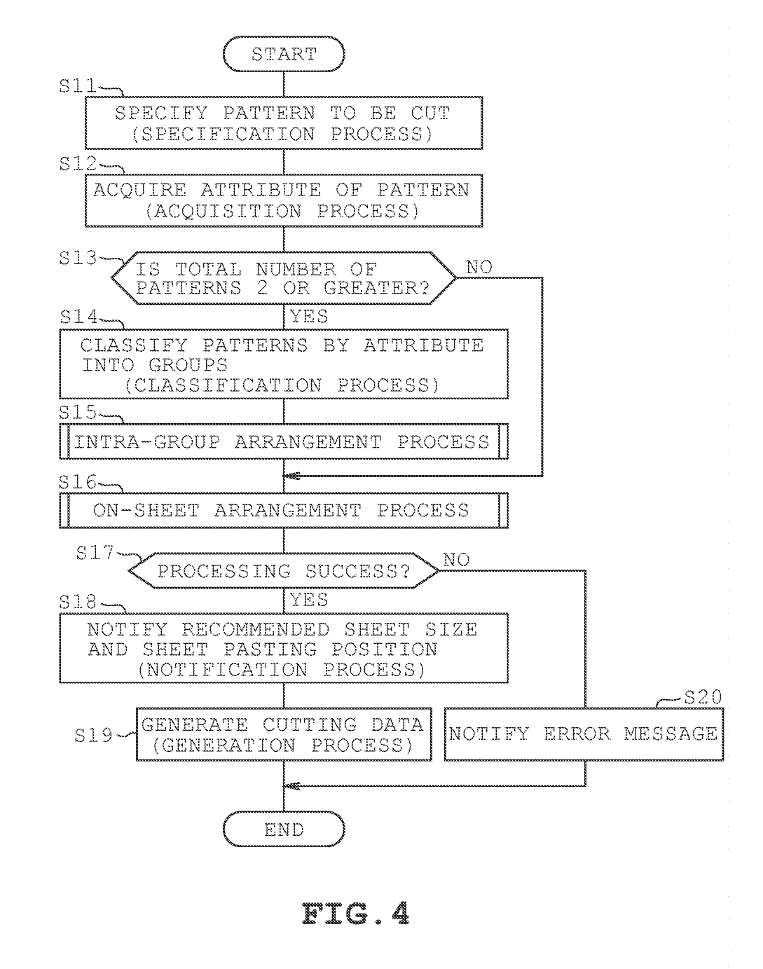

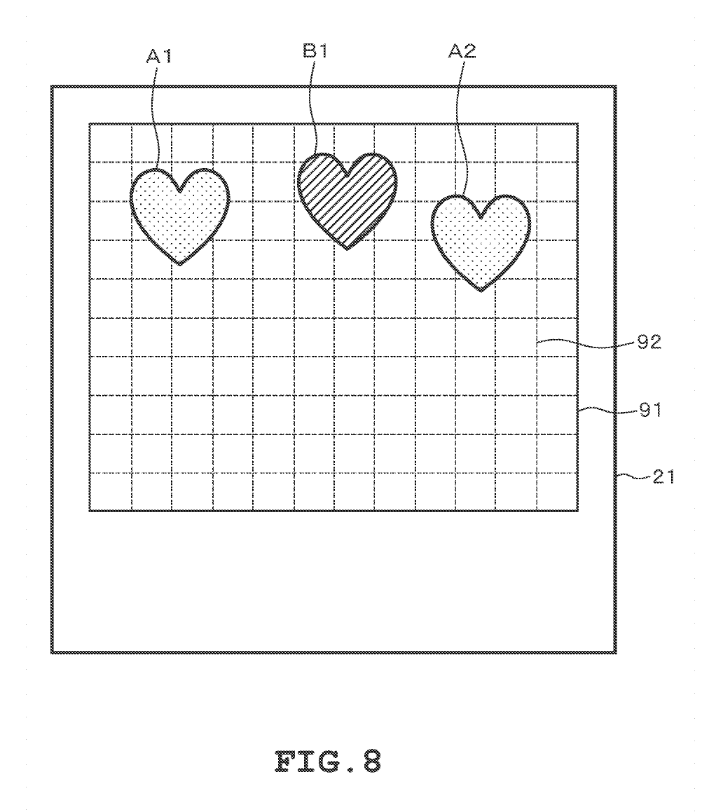

Next, control contents executed by the control circuit 30 will be described. Note that all the processes executed by the respective processing sections 31 to 35 will be described as processes executed by the control circuit 30 in the following description. Flowcharts shown in FIG. 4 to FIG. 7 show flows of the cutting data generating program executed by the control circuit 30. Hatching given to patterns in FIG. 8 or the like means a pattern color. That is, a difference in the pattern hatching means a difference in the pattern color.

When the power to the cutting apparatus 10 is turned on, the control circuit 30 executes the cutting data generating program. When executing the cutting data generating program, the control circuit 30 executes a specification process through an operation of the specification processing section 31 in step S11 in FIG. 4. The specification process is a process of specifying a plurality of patterns to be cut. For example, the user operates the various operation switches 22 while watching information on patterns or the like displayed on the display 21 and inputs information on a type of pattern or the number of patterns to be cut or the like. As shown in FIG. 8, suppose a case where the user selects three patterns: a green heart-shaped patterns A1 and A2, and a yellow heart-shaped pattern B1. In this case, there are two types of patterns: green heart-shaped pattern and yellow heart-shaped pattern.

As shown in FIG. 8, the display 21 displays, for example, the squares 92 as well as the allowable cutting range 91 of the holding member 90. The user selects, for example, the pattern A1, the pattern A2 and the pattern B1 as objects to be cut and arranges them within the allowable cutting range 91 displayed on the display 21. The control circuit 30 thus specifies that the pattern to be cut includes three patterns: pattern A1, pattern A2 and pattern B1. In this case, the control circuit 30 specifies patterns to be cut in order of patterns selected by the user and causes the display 21 to display the patterns. For example, when the user selects the patterns A1, B1 and A2 in that order, the control circuit 30 specifies the patterns to be cut in order of the patterns A1, B1 and A2, and causes the display 21 to display the respective patterns A1, B1 and A2 in that order.

More specifically, when the user selects the pattern A1 first, the control circuit 30 specifies the pattern A1 as the pattern to be cut and causes the display 21 to display the pattern A1. The user operates the various operation switches 22 while watching the pattern A1 displayed on the display 21 and arranges the pattern A1 at an arbitrary position within the allowable cutting range 91 displayed on the display 21. Next, when the user selects the pattern B1, the control circuit 30 specifies the pattern B1 as the pattern to be cut and causes the display 21 to display the pattern B1. The user arranges the pattern B1 in a free space where the pattern A1 is not arranged within the allowable cutting range 91 displayed on the display 21. The same applies to the pattern A2. In this case, the respective patterns A1, A2 and B2 are not arranged in order and a plurality of patterns with different colors are arranged mixed together.

Note that the specification process may be adapted so as to specify a pattern to be cut by the user selecting cutting data of a pattern as a single unit already generated. In this case, the control circuit 30 can specify the pattern based on a file name or the like assigned to the cutting data. If the cutting apparatus 10 is provided with a scanner function, the control circuit 30 may specify the pattern to be cut based on an image captured by the scanner function.

Next, in step S12 in FIG. 4, the control circuit 30 executes an acquisition process through an operation of the acquisition processing section 32. The acquisition process is a process of acquiring attribute information representing attributes of the patterns A1, A2 and B1 specified in the specification process. The respective patterns A1, A2 and B1 include attribute information as shown, for example, in FIG. 3. The attribute information represents the attributes of the respective patterns A1, A2 and B1, and is, for example, a color and a shape name. In the case of the present embodiment, the attributes of the patterns A1 and A2 are color “green” and shape name “heart.” The attributes of the pattern B1 is color “yellow” and shape name “heart.”

Note that these pieces of attribute information may be stored in association with each pattern or may be included in cutting data in which those patterns are cut. It is also possible to specify a pattern to be cut based on an image captured by the scanner function, specify a color or shape or the like of the pattern and store them in association with the pattern as attribute information of the pattern.

Next, in step S13 in FIG. 4, the control circuit 30 determines whether or not the total number of patterns to be cut is two or more. When the total number of patterns to be cut is 1 (NO in step S13), the control circuit 30 moves the process to step S16. On the other hand, when the total number of patterns to be cut is two or more (YES in step S13), the control circuit 30 moves the process to step S14. In step S14, the control circuit 30 executes a classification process through an operation of the classification processing section 33. The classification process is a process of classifying the respective patterns into one or more groups based on the attribute information of the patterns acquired in the acquisition process. Each group includes at least one pattern.

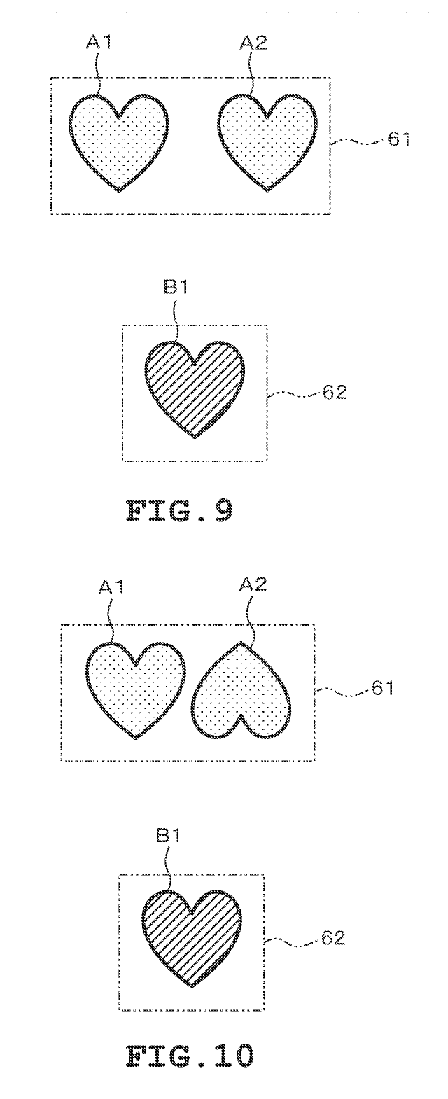

For example, in the present embodiment, group classification is performed according to colors of the patterns A1, A2 and B1 to be cut. That is, in this case, the control circuit 30 classifies the respective patterns A1, A2 and B1 into a first group 61 and a second group 62 as shown in FIG. 9. The first group 61 is composed of the patterns A1 and A2 having an attribute of color “green.” The second group 62 is composed of the pattern B1 having an attribute of color “yellow.”

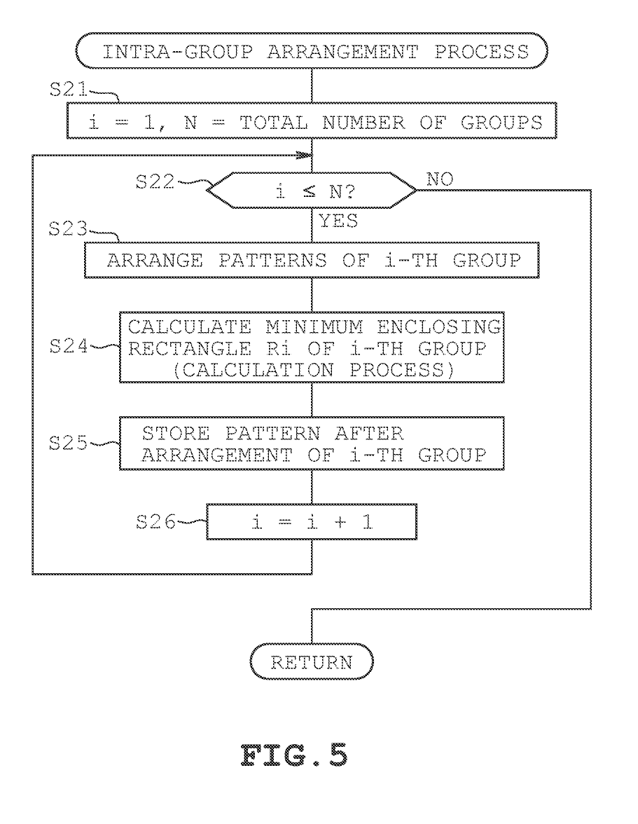

Next, in step S15 in FIG. 4, the control circuit 30 executes an intra-group arrangement process. The intra-group arrangement process is a process of rearranging the respective patterns at appropriate positions for each group classified in the classification process and thereby optimizing distance relationships among the respective patterns belonging to the same group. More specifically, a process shown in FIG. 5 is executed. When executing the intra-group arrangement process, the control circuit 30 sets variable i=1 and N=the total number of groups as initial settings in step S21 in FIG. 5. For example, when the objects to be cut are assumed to be patterns A1, A2 and B1 as described above, since the total number of groups is 2, N=2. Furthermore, variable i is a positive integer of 1 or greater.

Next, in step S22, the control circuit 30 determines whether or not variable i is N or less. The control circuit 30 repeats steps S22 to S26 until variable i exceeds N. When variable i is equal to or less than N (YES in step S22), the control circuit 30 moves to step S23 and arranges patterns of the i-th group at optimum positions. A conventionally used technique such as nesting can be adopted for this optimization of pattern arrangement.

The control circuit 30 minimizes distances between respective patterns within an allowable cutting range of the cutting apparatus 10 while rotating the respective patterns of each group as shown, for example, in FIG. 10. For example, when variable i=1, the control circuit 30 optimizes the arrangement of the patterns A1 and A2 belonging to the first group 61 as shown in FIG. 10. Similarly, when variable i=2, the control circuit 30 optimizes the arrangement of the pattern B1 belonging to the second group 62.

For example, in the case of the present embodiment, i=1 and N=2 are set as an initial setting in step S21. In this case, since i is 2 or less in step S22 (YES in step S22), the control circuit 30 arranges the respective patterns A1 and A2 of the first group 61 in step S23. More specifically, the control circuit 30 arranges the respective patterns so as to obtain such a positional relationship that the distance between the patterns A1 and A2 is minimized within an allowable cutting range of the cutting apparatus 10. The control circuit 30 calculates a minimum enclosing rectangle R1 of the first group 61 in step S24, and then stores the patterns A1 and A2 after the arrangement of the first group 61 in step S25. More specifically, the control circuit 30 stores each pattern in association with a positional relationship with other patterns. The control circuit 30 adds 1 to i to obtain i=2 in step S26.

Next, since i is also equal to or less than 2 in step S22 (YES in step S22), the control circuit 30 arranges the pattern B1 of the second group 62 in step S23. The control circuit 30 calculates a minimum enclosing rectangle R2 of the second group 62 in step S24, and then stores the pattern B1 after the arrangement of the second group 62 in step S25. The control circuit 30 adds 1 to i to obtain i=3 in step S26. Then, since i exceeds 2 in step S22 (NO in step S22), the control circuit 30 ends the intra-group arrangement process (return).

The control circuit 30 executes a calculation process through an operation of the calculation processing section 35 in step S24 in FIG. 5. The calculation process calculates an enclosing rectangle which is a rectangle including all patterns belonging to the same group. In the present embodiment, the control circuit 30 calculates a minimum enclosing rectangle Ri of each group. Character “i” of Ri represents a group number and the value of variable i is substituted for “i.” For example, the minimum enclosing rectangle R1 is a minimum enclosing rectangle of the first group 61 and a minimum enclosing rectangle R2 is a minimum enclosing rectangle of the second group 62. Note that when the minimum enclosing rectangle of each group is generically represented, a minimum enclosing rectangle R is used.

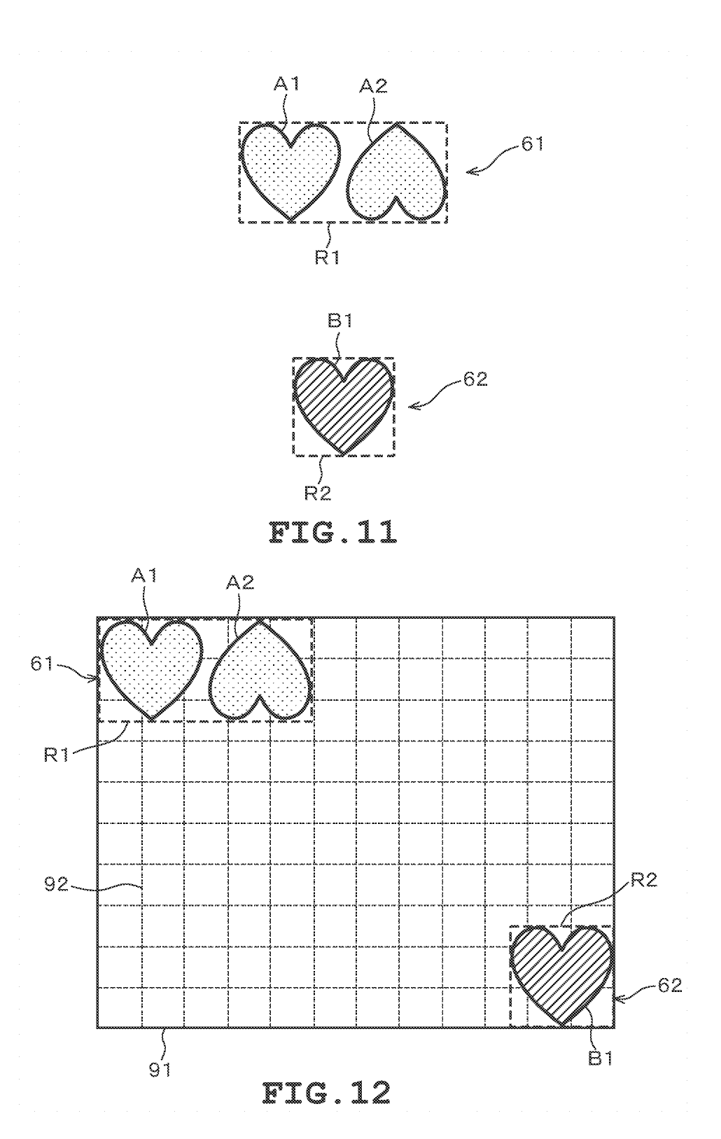

The minimum enclosing rectangle R is an aspect of an enclosing rectangle and included in the concept of an enclosing rectangle. The minimum enclosing rectangle R is a rectangle contacting the outside shapes of patterns belonging to the same group. The size of the minimum enclosing rectangle R becomes the size of the object to be cut 100, which is minimally necessary to cut the pattern arranged within the minimum enclosing rectangle R. As shown in FIG. 11, for example, the minimum enclosing rectangle R1 of the first group 61 is a rectangle contacting the outside shapes of the patterns A1 and A2, and includes all the patterns A1 and A2, belonging to color “green.”

In step S25 in FIG. 5, the control circuit 30 stores the patterns after the arrangement of each group 61 or 62 and then adds 1 to variable i in step S26. The control circuit 30 repeats steps S22 to S26, executes the processes in steps S22 to S26 for all groups and then ends the intra-group arrangement processing (return).

Next, in step S16 in FIG. 4, the control circuit 30 executes an on-sheet arrangement process. The on-sheet arrangement process is a process of virtually arranging each pattern to be cut within the allowable cutting range 91. The “virtually arranging a pattern” in the description of the present embodiment represents a process executed in the control circuit 30. In this case, it is not questionable whether or not the result of virtually arranging a pattern is represented and visualized on the display 21 or the like.

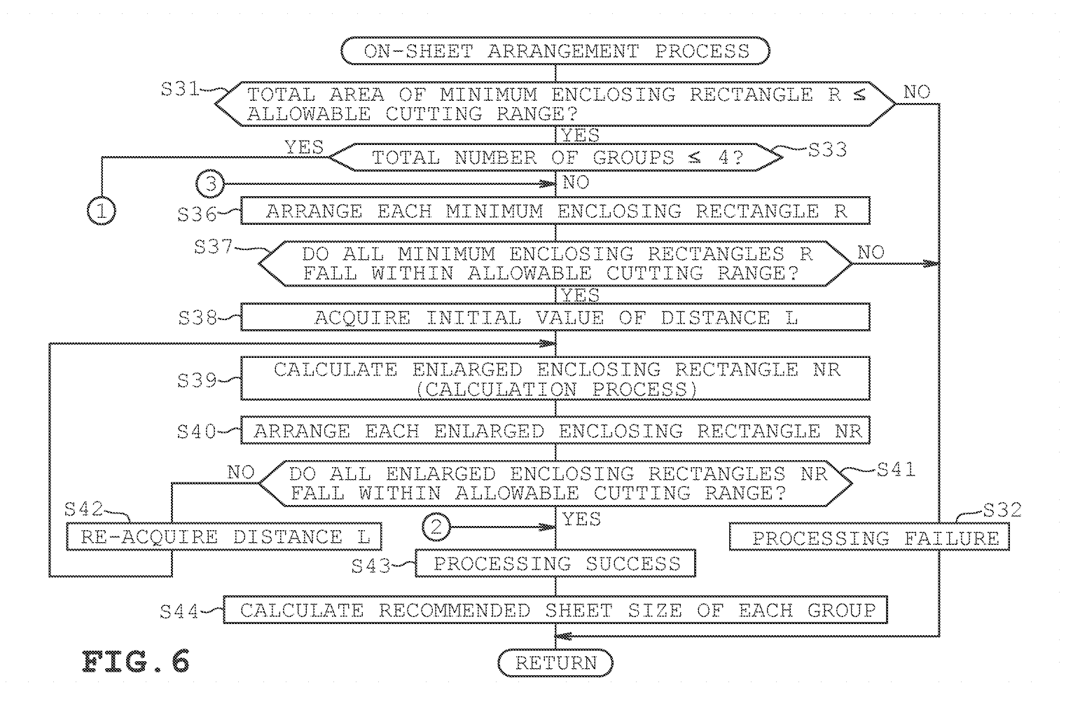

When executing the on-sheet arrangement process, the control circuit 30 first determines in step S31 shown in FIG. 6 whether or not the sum total of areas of the minimum enclosing rectangles R of the respective groups is equal to or less than the area of the allowable cutting range 91. The area of the allowable cutting range 91 is stored in the ROM, RAM or the like of the control circuit 30 in advance. When the sum total of the areas of the minimum enclosing rectangles R of the respective groups exceeds the area of the allowable cutting range 91, it is physically impossible to arrange all the patterns inside the allowable cutting range 91. Therefore, when the sum total of the areas of the minimum enclosing rectangles R of the respective groups exceeds the area of the allowable cutting range 91 (NO in step S31), the control circuit 30 moves the process to step S32. The control circuit 30 stores “processing failure” in step S32 and moves the process to step S17 in FIG. 4 (return).

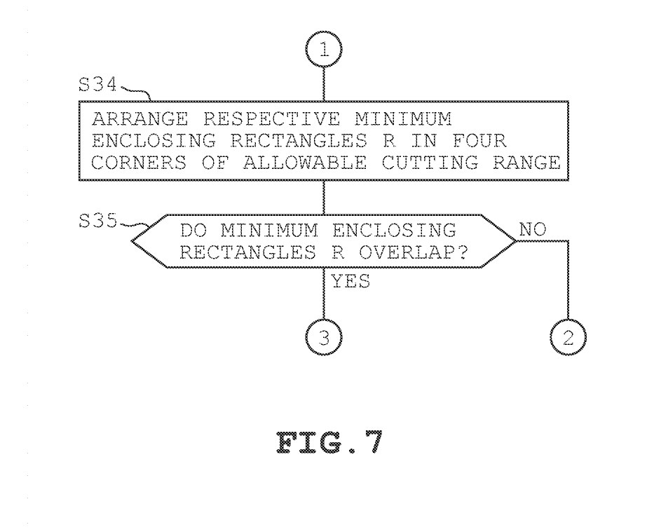

On the other hand, when the sum total of the areas of the minimum enclosing rectangles R of the respective groups is equal to or less than the area of the allowable cutting range 91 (YES in step S31 in FIG. 6), the control circuit 30 moves the process to step S33. In step S33, the control circuit 30 determines whether or not the total number of groups is equal to or less than 4. When the total number of groups is equal to or less than 4 (YES in step S33), the control circuit 30 moves the process to step S34 in FIG. 7. In step S34, the control circuit 30 arranges the minimum enclosing rectangles R of the respective groups in the four corners of the allowable cutting range 91 and thus, virtually arranges the patterns of the respective groups on the holding member 90. The “arrangement of a minimum enclosing rectangle R” means an arrangement of the respective patterns while maintaining the positional relationship between the respective patterns included in the minimum enclosing rectangle R.

In this case, the control circuit 30 arranges the minimum enclosing rectangle R using corners of the allowable cutting range 91 as references. More specifically, the control circuit 30 arranges each minimum enclosing rectangle R so as to align one corner of the minimum enclosing rectangle R with a corner of the allowable cutting range 91. Note that the corner of the minimum enclosing rectangle R need not be completely aligned with the corner of the allowable cutting range 91, and a margin on the order of several mm may be provided.

In the case of the present embodiment, for example, as shown in FIG. 12, the minimum enclosing rectangle R1 of the first group 61 is arranged in the upper left corner of the allowable cutting range 91. In that case, the control circuit 30 causes the corner at the upper left of the minimum enclosing rectangle R1 to be aligned with the corner at the upper left of the allowable cutting range 91. In this way, the patterns A1 and A2 belonging to the first group 61 are virtually arranged within the minimum enclosing rectangle R1 arranged in the upper left corner of the allowable cutting range 91. The minimum enclosing rectangle R2 of the second group 62 is arranged in the lower right corner of the allowable cutting range 91. In that case, the control circuit 30 causes the lower right corner of the minimum enclosing rectangle R2 to be aligned with the lower right corner of the allowable cutting range 91. As a result, the pattern B1 belonging to the second group 62 is virtually arranged in the minimum enclosing rectangle R2 arranged in the lower right corner of the allowable cutting range 92.

After that, in step S35 in FIG. 7, the control circuit 30 determines whether or not the respective minimum enclosing rectangles R overlap with each other. When the respective minimum enclosing rectangles R overlap with each other (YES in step S35), the control circuit 30 moves the process to step S36 in FIG. 6. On the other hand, when the respective minimum enclosing rectangles R do not overlap with each other (NO in step S35), the control circuit 30 moves the process to step S43 in FIG. 6. In step S43, the control circuit 30 stores “processing success,” calculates a recommended sheet size with respect to the respective groups 61 and 62 in step S44, and then moves the process to step S17 in FIG. 4 (return).

The recommended sheet sizes are calculated based on the minimum enclosing rectangles R1 and R2 of the respective groups 61 and 62. For example, when the minimum enclosing rectangle R1 of the first group 61 is greater than A6 standard sheet and smaller than A5 standard sheet, the recommended sheet size of the first group 61 becomes A5. Similarly, for example, when the minimum enclosing rectangle R2 of the second group 62 is greater than A7 standard sheet and smaller than A6 standard sheet, the recommended sheet size of the second group 62 becomes A6.

In step S17, the control circuit 30 determines whether or not the on-sheet arrangement process in step S16 is a success. When the on-sheet arrangement process is a failure (NO in step S17), the control circuit 30 moves the process to step S20 and notifies the user that the process ends up in a failure. In this case, the control circuit 30 displays, for example, an error message on the display 21. A specific example of this error message is “Automatic arrangement is not successful, and so the process will be ended.”

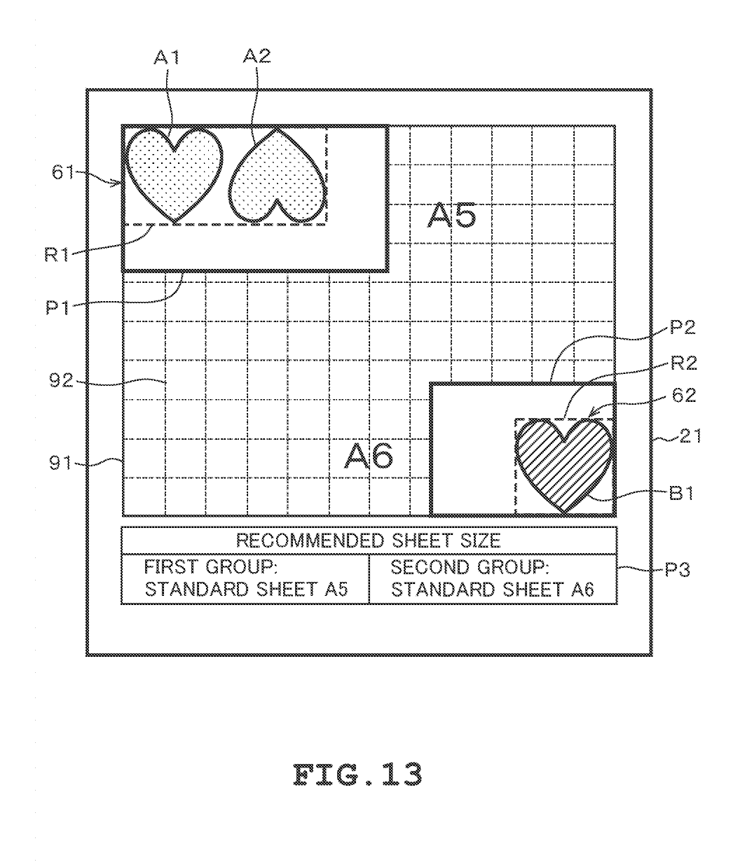

On the other hand, when the on-sheet arrangement process is a success (YES in step S17), the control circuit 30 moves the process to step S18 and executes a notification process. The notification process is a process of notifying the user of information on an arrangement position of each pattern in the allowable cutting range 91 of the holding member 90, information on a recommended sheet size corresponding to each group and information on a pasting position of each sheet with respect to the holding member 90 or the like. The above respective pieces of information are displayed, for example, on the display 21 as shown in FIG. 13. The display 21 displays, for example, a graphic P1 illustrating the size and pasting position of the recommended sheet of the first group 61, a graphic P2 illustrating the size and pasting position of the recommended sheet of the second group 62, and character information P3 illustrating the sizes of the recommended sheets of the respective groups 61 and 62. In this case, the display 21 also displays a frame showing the allowable cutting range 91 and squares 92.

After that, in step S19, the control circuit 30 generates cutting data through an operation of the generation processing section 34. In this way, the control circuit 30 generates cutting data in which the respective patterns are arranged so that the minimum enclosing rectangles R of the respective groups do not overlap with each other. The cutting data corresponds to the respective patterns automatically arranged by the aforementioned process and includes all the patterns to be cut, that is, the patterns A1, A2 and B1 in this case. The control circuit 30 then ends a series of processes (end in FIG. 4).

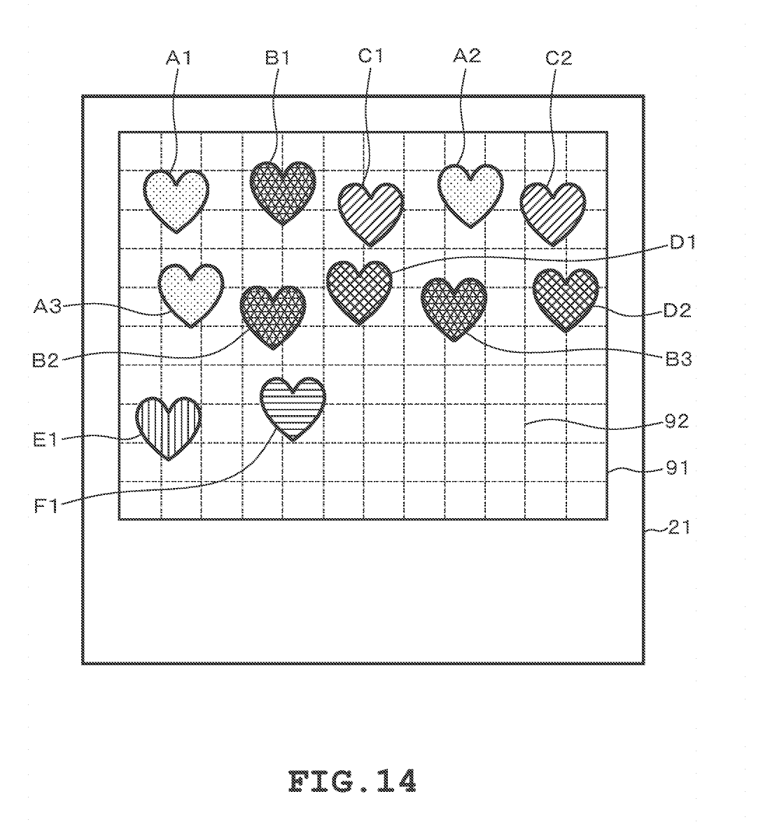

Furthermore, when the total number of groups exceeds 4 (NO in step S33 in FIG. 6) or when the total number of groups is equal to or less than 4 (YES in step S33) and the respective minimum enclosing rectangles R overlap with each other (YES in step S35 in FIG. 7), the control circuit 30 executes steps S36 to S44 in FIG. 6. Here, a case is assumed where six types of pattern are specified as shown in FIG. 14.

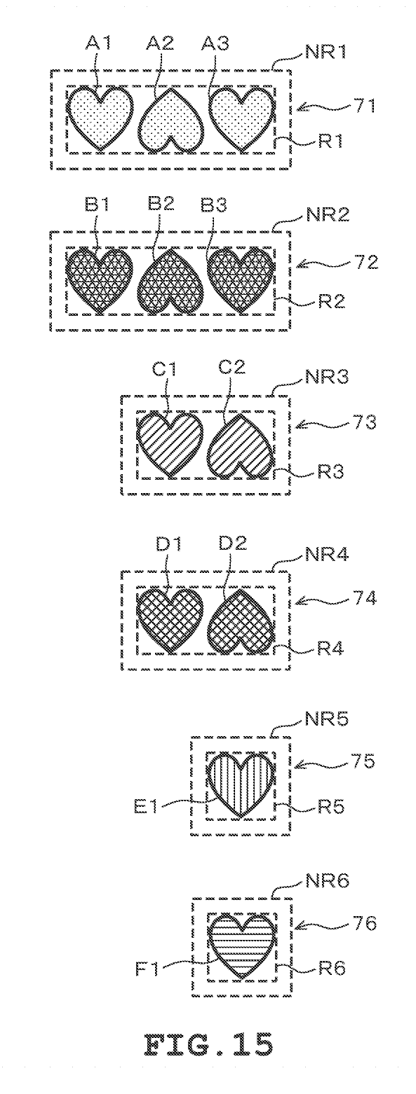

The patterns A1, A2 and A3 among the respective patterns shown in FIG. 14 have the same attribute and belong to a first group 71. The patterns B1, B2 and B3 have the same attribute and belong to a second group 72. Patterns C1 and C2 have the same attribute and belong to a third group 73. Patterns D1 and D2 have the same attribute and belong to a fourth group 74. A pattern E1 and a pattern F1 belong to a fifth group 75 and a sixth group 76 respectively. In this case, the respective patterns A1 to A3, B1 to B3, C1, C2, D1, D2, E1 and F1 are not aligned in a line and are arranged in a mixture of a plurality of colors. The patterns are classified into the same groups respectively through the aforementioned process as shown in FIG. 15 and the minimum enclosing rectangle R is calculated for each group.

Upon determining in step S33 that the total number of groups exceeds 4 (NO in step S33), the control circuit 30 moves the process to step S36. In step S36, the control circuit 30 packs and virtually arranges the respective minimum enclosing rectangles R1 to R6 of each group 71 to 76 within the allowable cutting range 91 such that the respective minimum enclosing rectangles R do not overlap with each other. The control circuit 30 moves the process to step S37.

Next, in step S37, the control circuit 30 determines whether or not all the minimum enclosing rectangles R1 to R6 of each group 71 to 76 fall within the allowable cutting range 91. When all the minimum enclosing rectangles R1 to R6 of each group 71 to 76 do not fall within the allowable cutting range 91 (NO in step S37), the control circuit 30 moves the process to step S32. In step S32, the control circuit 30 stores “processing failure” and moves the process to step S17 in FIG. 4 (return). On the other hand, when all the minimum enclosing rectangles R1 to R6 of each group 71 to 76 fall within the allowable cutting range 91 (YES in step S37), the control circuit 30 moves the process to step S38.

In step S38 in FIG. 6, the control circuit 30 acquires an initial value of a distance L. The distance L indicates a target value of a distance between two mutually adjacent patterns belonging to different groups among a plurality of patterns virtually arranged on the holding member 90. The initial value of the distance L may be stored in advance by the control circuit 30 or may be determined by an input by the user.

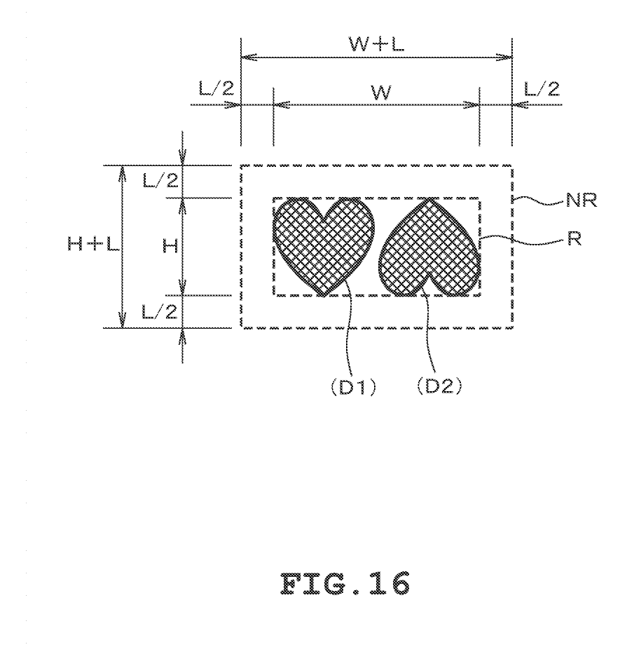

Next, in step S39, the control circuit 30 calculates an enlarged enclosing rectangle NR of each group through an operation of the calculation processing section 35, in this case, enlarged enclosing rectangles NR1 to NR6. As shown in FIG. 15 and FIG. 16, the enlarged enclosing rectangle NR corresponds to the minimum enclosing rectangle R enlarged by a predetermined range. The enlarged enclosing rectangle NR is an aspect of the enclosing rectangle and is included in the concept of the enclosing rectangle. In the case of the present embodiment, the enlarged enclosing rectangle NR is a rectangle obtained by enlarging a perimeter of the minimum enclosing rectangle R by L/2 as shown in FIG. 16. That is, a predetermined range by which the minimum enclosing rectangle R is enlarged is the distance L. In this case, the width of the enlarged enclosing rectangle is W+L and the height is H+L where the width of the minimum enclosing rectangle is assumed to be W and the height is assumed to be H.

Next, in step S40, the control circuit 30 virtually arranges the respective enlarged enclosing rectangles NR1 to NR6 of each group 71 to 76 on the allowable cutting range 91 such that the respective enlarged enclosing rectangles NR do not overlap with each other. In this case, the “arrangement of enlarged enclosing rectangles NR” means that the respective patterns are arranged while maintaining the positional relationships between the respective patterns included in the enlarged enclosing rectangle NR.

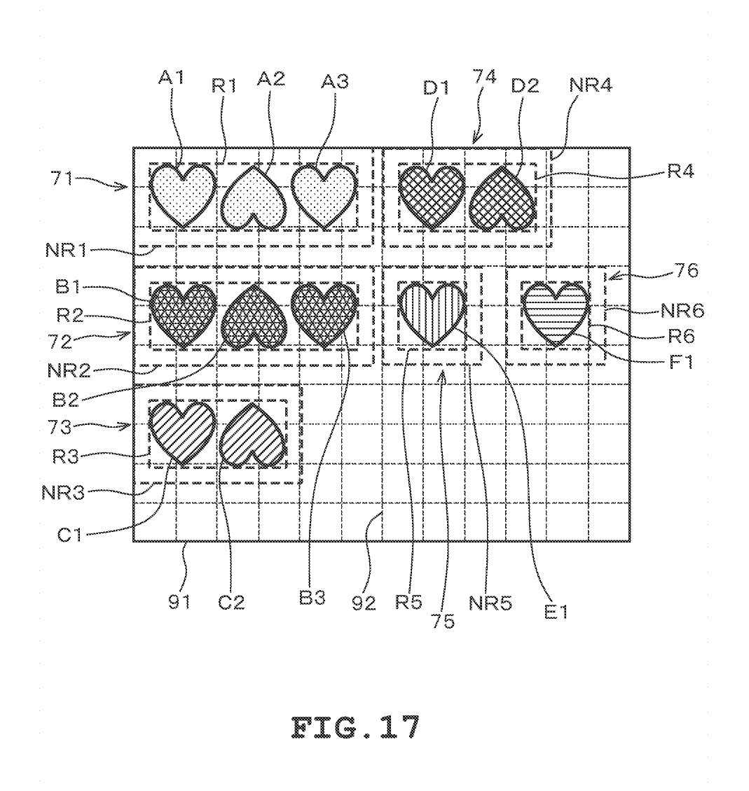

When virtually arranging the respective enlarged enclosing rectangles NR, the control circuit 30 packs and arranges the enlarged enclosing rectangles NR in order starting with one having the largest area along the squares 92 using the upper left corner of the allowable cutting range 91 as the reference as shown, for example, in FIG. 17. In this case, the control circuit 30 arranges the enlarged enclosing rectangle NR by aligning at least one side of the enlarged enclosing rectangle NR with ruler lines that constitute the squares 92. According to the present embodiment, the control circuit 30 arranges the enlarged enclosing rectangle NR so as to align one corner thereof with the corner of the square 92. Note that the corner of the enlarged enclosing rectangle NR and the corner of the allowable cutting range 91, and the corner of the enlarged enclosing rectangle NR and the corners of the squares 92 need not be completely aligned, but a margin on the order of several mm may be provided.

Next, in step S41 in FIG. 6, the control circuit 30 determines whether or not all the enlarged enclosing rectangles NR1 to NR6 of each group 71 to 76 fall within the allowable cutting range 91. When all the enlarged enclosing rectangles NR1 to NR6 of each group 71 to 76 do not fall within the allowable cutting range 91 (NO in step S41), the control circuit 30 moves the process to step S42. In step S42, the control circuit 30 causes the display 21 to perform a display so that, for example, a distance L, which is smaller than the current distance L is re-inputted urging the user to re-input the distance L. The control circuit 30 acquires the distance L re-inputted by the user again and re-executes step S39 and subsequent steps. Note that the distance L in step S42 may be acquired again not by an input by the user but, for example, by automatically reducing the distance L in the control circuit 30.

On the other hand, when all the enlarged enclosing rectangles NR1 to NR6 of each group 71 to 76 fall within the allowable cutting range 91 (YES in step S41), the control circuit 30 moves the process to step S43 and stores “processing success.” In step S44, the control circuit 30 calculates a recommended sheet size with respect to each group 71 to 76 and then moves the process to step S17 in FIG. 4 (return).

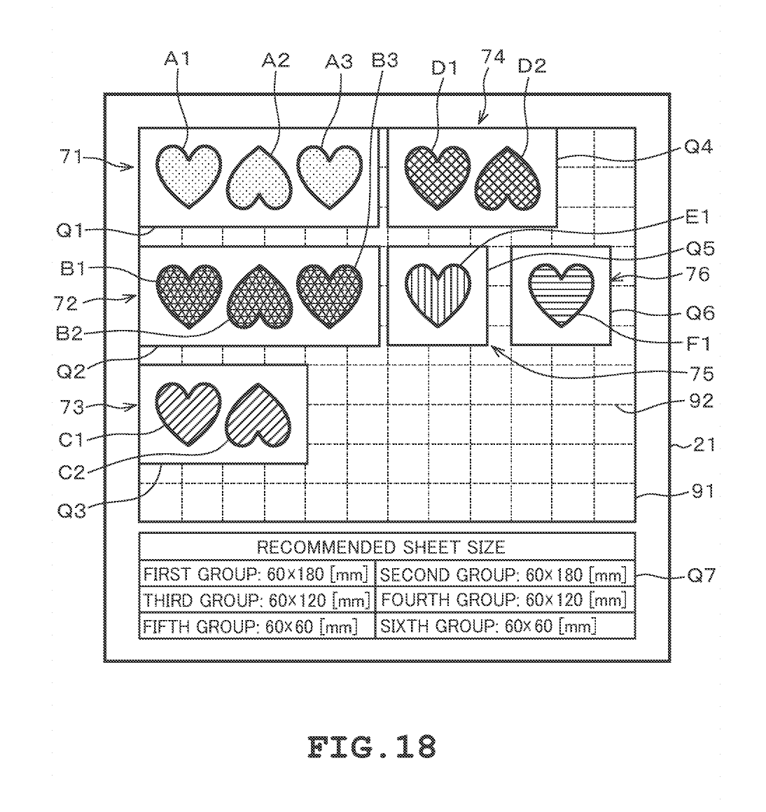

When the on-sheet arrangement process results in a failure (NO in step S17), the control circuit 30 moves the process to step S20 and causes the display 21 to display the aforementioned error message. On the other hand, when the on-sheet arrangement process results in a success (YES in step S17), the control circuit 30 moves the process to step S18 and executes a notification process. In this way, as shown in FIG. 18, the display 21 displays graphics Q1 to Q6 illustrating the size of a recommended sheet of each group 71 to 76 and a sheet pasting position and character information Q7 illustrating the size of the recommended sheet of each group 71 to 76.

In this case, the recommended sheet size is calculated based on the enlarged enclosing rectangles NR1 to NR6 of each group 71 to 76. Here, if standard sheets are used, for example, for all the groups 71 to 76, all the sheets may not fall within the allowable cutting range 91. In this case, as shown, for example, in FIG. 18, the control circuit 30 causes the display 21 to display the enlarged enclosing rectangles NR1 to NR6 of each group 71 to 76 and graphics Q1 to Q6 illustrating their respective positions.

In the present embodiment, the recommended sheet size is represented by the number of horizontal and vertical squares 92 in the cases of graphics Q1 to Q6 and represented by numerical values such as height H [mm]×width W [mm] in the case of character information Q7 as shown in FIG. 18. In this case, numbers may be assigned to, for example, the ruler lines in the vertical direction and the horizontal direction constituting the square 92 and the number of the ruler line corresponding to the square 92 at the recommended sheet pasting position may be displayed on the display 21. For example, the following display may be adopted. That is, numbers are assigned to all the squares 92. The display 21 may display a number of the square 92 with which the corner of the recommended sheet is aligned or numbers of three squares 92 which are adjacent to the square 92 with which the corner of the recommended sheet is aligned and which are not hidden behind the recommended sheet when the recommended sheet is pasted thereto.

In step S19, the control circuit 30 generates cutting data through an operation of the generation processing section 34. The control circuit 30 thereby generates cutting data after automatically arranging the respective patterns. This cutting data includes patterns to be cut, in this case, all the patterns A1 to A3, B1 to B3, C1, C2, D1, D2, E1 and F1.

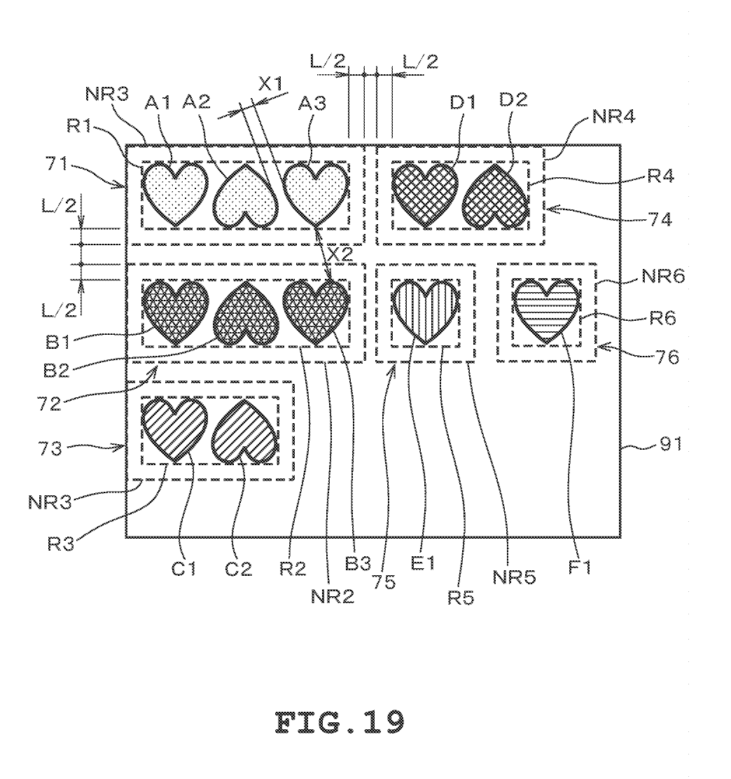

Furthermore, as shown in FIG. 19, among patterns belonging to different groups, two neighboring patterns are arranged separated apart by at least the distance L. Here, a case will be described where an arbitrary one pattern among the plurality of patterns, for example, the pattern A3 is used as the reference. In this case, the distance between the pattern A3 used as the reference and the other pattern A2 belonging to the same first group 71 to which the pattern A3 used as the reference belongs and adjacent to the pattern A3 used as the reference is assumed to be X1. Furthermore, the distance between the pattern A3 used as the reference and the other pattern B3 belonging to a group different from that of the pattern A3 used as the reference, for example, the second group 72 and adjacent to the pattern A3 used as the reference is assumed to be X2. In this case, the control circuit 30 arranges the respective patterns so that the distance X2 becomes larger than the distance X1. In the present embodiment, the distance X1 and the distance X2 are both such distances that the distance between a pattern used as the reference and another adjacent pattern becomes the shortest.

Note that if the distance L is set so that the distance X2 is larger than the distance X1, the corner of each enlarged enclosing rectangle NR need not be aligned with the corner of the squares 92 as shown in FIG. 17 and FIG. 18. In this case, the respective enlarged enclosing rectangles NR may contact each other without overlapping with each other.

After that, the control circuit 30 ends a series of processes (end in FIG. 4). The cutting apparatus 10 operates the cutting mechanism based on the cutting data generated in step S19, and can thereby cut all the patterns to be cut.

According to the embodiment described so far, when the patterns to be cut include a mixture of a plurality of patterns with different attributes, the cutting apparatus 10 classifies the respective patterns into groups each being composed of patterns with the same attribute. Cutting data is generated in which each pattern is virtually arranged for each group. According to this, respective patterns are arranged in groups classified by attribute. Therefore, even when a plurality of patterns with different attributes such as color are considered to be objects to be cut, this eliminates the possibility that a plurality of types of patterns with different attributes may be arranged in a mixture of patterns with different attributes, that is, in a condition in which patterns with their respective attributes are mixed together. Thus, the user needs only to arrange objects to be cut according to an attribute of patterns constituting each group, and as a result, the user can easily arrange the respective objects to be cut on the holding member.

Furthermore, the control circuit 30 generates cutting data in which respective patterns are arranged as shown, for example, n FIG. 19, such that a distance between adjacent patterns belonging to different groups, for example, the distance X2 between the pattern A3 and the pattern B3 is larger than a distance between adjacent patterns in the same group, for example, the distance X1 between the pattern A3 and the pattern A2. According to this, it is possible to reduce wastage of the objects to be cut 100 by reducing a distance between patterns belonging to the same group. Moreover, by increasing the distance between groups, it is easier to arrange the objects to be cut 100 corresponding to the respective groups on the holding member 90.

Furthermore, the control circuit 30 calculates an enclosing rectangle which is a rectangle including all patterns belonging to the same group, for example, the minimum enclosing rectangle R or the enlarged enclosing rectangle NR. The control circuit 30 generates cutting data in which patterns are arranged so that the minimum enclosing rectangles R or enlarged enclosing rectangles NR of the respective groups do not overlap with each other. According to this, by calculating the size and position of the objects to be cut 100 to be arranged on the holding member 90 using the minimum enclosing rectangle R or the enlarged enclosing rectangle NR as the reference, this prevents the objects to be cut 100 arranged on the holding member 90 from overlapping with each other. This makes it easier to arrange the objects to be cut 100 on the holding member 90.

Furthermore, the control circuit 30 generates cutting data in which patterns are arranged such that the enlarged enclosing rectangles NR do not overlap with each other. That is, the control circuit 30 generates cutting data in which patterns belonging to other groups are arranged outside a range obtained by enlarging the minimum enclosing rectangle R by a predetermined distance L. This makes it possible to secure a large distance between groups, and thereby further facilitate the arrangement of the objects to be cut 100. Note that the predetermined distance by which the minimum enclosing rectangle R is enlarged may be the same distance in the vertical and horizontal directions of the minimum enclosing rectangle R or may be different distances in the respective directions.

When the total number of groups is equal to or less than 4, the control circuit 30 generates cutting data in which respective patterns are arranged by aligning the corners of the minimum enclosing rectangle R or enlarged enclosing rectangle NR for each group with each of the corners of the allowable cutting range 91. Thus, when the total number of groups is equal to or less than 4, the user can arrange the objects to be cut 100 on the holding member 90 so that the corners of the object to be cut 100 are aligned with the corners of the allowable cutting range 91, and thereby further facilitate the arrangement of the object to be cut 100.

The holding member 90 includes squares 92 arranged at a predetermined interval. When the total number of groups exceeds 4 or when the total number of groups is equal to or less than 4 and the enclosing rectangles N and NR of the respective groups are arranged in the four corners of the allowable cutting range 91, if the respective enclosing rectangles N and NR overlap with each other, the control circuit 30 generates cutting data by aligning the corners of the minimum enclosing rectangle R or the enlarged enclosing rectangle NR with the corners of the squares 92. Thus, the user can arrange the objects to be cut 100 on the holding member 90 such that the corners of the objects to be cut 100 are aligned with the corners of the allowable cutting range 91 or the corners of the objects to be cut 100 are aligned with the corners of the squares 92, and thereby further facilitate the arrangement of the objects to be cut 100.

The cutting apparatus 10 displays the sizes of the objects to be cut 100 determined by the minimum enclosing rectangle N or enlarged enclosing rectangle NR and the positions at which the objects to be cut 100 should be arranged on the holding member 90 on the display 21. This allows the user to easily confirm the sizes of the objects to be cut 100 and the positions at which the objects to be cut 100 should be arranged on the holding member 90.

The present disclosure is not limited to only the above-described embodiment, but can be expanded or modified in various ways without departing from the spirit and scope of the present disclosure.

The above-described embodiment has described an example where a plurality of patterns are classified into two groups or four groups, but the present invention is not limited to such numbers of groups. The processes of the above-described embodiment are also applicable to a case where the number of groups is one as a result of classifying specified patterns or also applicable to cases where the patterns are classified into three groups or further five or more groups.

The aforementioned cutting data generating program is recorded not only in the control circuit 30 of the cutting apparatus 10 but also in various types of recording medium such as a USB memory, CD-ROM, flexible disk, DVD, memory card. In this case, operations and effects similar to those of the above-described embodiment can be exerted by causing computers of various data processing apparatuses to read and execute the program recorded in the recording medium.

In the embodiments described above, a single CPU may perform all of the processes. Nevertheless, the disclosure may not be limited to the specific embodiment thereof, and a plurality of CPUs, a special application specific integrated circuit (“ASIC”), or a combination of a CPU and an ASIC may be used to perform the processes.

The foregoing description and drawings are merely illustrative of the principles of the disclosure and are not to be construed in a limited sense. Various changes and modifications will become apparent to those of ordinary skill in the art. All such changes and modifications are seen to fall within the scope of the disclosure as defined by the appended claims.

We claim:

1. A cutting apparatus comprising:
a cutting mechanism configured to cut an object to be cut based on cutting data; and
a controller configured to:
specify a plurality of patterns;
acquire attribute information representing an attribute of the specified patterns;
classify the respective patterns into two or more groups based on the acquired attribute information;
generate the cutting data in which the patterns are arranged for each of the classified groups; and
control the cutting mechanism to cut the patterns based on the generated cutting data.

2. The cutting apparatus according to claim 1,
the controller being further configured to:
generate, when an arbitrary one of the plurality of patterns is used as a reference, the cutting data in which the plurality of patterns are arranged in a manner that a distance between the pattern used as the reference and another pattern belonging to a group different from the group of the pattern used as the reference and adjacent to the pattern used as the reference is larger than a distance between the pattern used as the reference and the other pattern belonging to a same group as the group of the pattern used as the reference and adjacent to the pattern used as the reference.

3. The cutting apparatus according to claim 1,
the controller being further configured to:
calculate an enclosing rectangle including all the patterns belonging to the same group; and
generate the cutting data in which the respective patterns are arranged in a manner that the enclosing rectangles of the respective groups do not overlap with each other.

4. The cutting apparatus according to claim 3,
the controller being further configured to:
generate the cutting data in which the patterns belonging to the other group are arranged outside a range obtained by enlarging the calculated enclosing rectangle by a predetermined distance.

5. The cutting apparatus according to claim 3, wherein the cutting apparatus further comprises a holding member having a rectangular shape and configured to hold the object to be cut, and
the controller being further configured to:
generate, when the number of classified groups is four or less, the cutting data in which the respective patterns are arranged by aligning corners of the enclosing rectangle for the respective groups with each of four corners of a rectangular allowable cutting range determined by the holding member.

6. The cutting apparatus according to claim 3, wherein the cutting apparatus further comprises a holding member comprising squares arranged at a predetermined interval, and
the controller being further configured to:
generate the cutting data in which the respective patterns are arranged by aligning the corners of the enclosing rectangle with corners of the squares.

7. The cutting apparatus according to claim 3, wherein the cutting apparatus further comprises a holding member configured to hold the object to be cut, and
the controller being further configured to:
notify a size of the object to be cut determined by the enclosing rectangle and a position at which the object to be cut is to be arranged on the holding member.

8. The cutting apparatus according to claim 1,
the controller being further configured to:
acquire color information representing a color of the pattern as the attribute information.

9. A non-transitory recording medium configured to store a cutting data generating program for generating cutting data used for a cutting apparatus having a cutting mechanism and a holding member configured to hold an object to be cut,
the cutting data generating program including instructions for a computer which has a controller,
the instructions cause, when executed by the controller, the computer to:
specify a plurality of patterns;
acquire attribute information representing an attribute of the specified patterns;
classify the respective patterns into two or more groups based on the acquired attribute information;
generate the cutting data in which the patterns are arranged for each of the classified groups; and
control the cutting mechanism to cut the patterns based on the generated cutting data.

10. The non-transitory recording medium according to claim 9,
the instructions further cause, when executed by the controller, the computer to:
generate, when an arbitrary one of the plurality of patterns is used as a reference, the cutting data in which the plurality of patterns are arranged in a manner that a distance between the pattern used as the reference and another pattern belonging to a group different from the group of the pattern used as the reference and adjacent to the pattern used as the reference is larger than a distance between the pattern used as the reference and the other pattern belonging to a same group as the group of the pattern used as the reference and adjacent to the pattern used as the reference.

11. The non-transitory recording medium according to claim 9,
the instructions further cause, when executed by the controller, the computer to:
calculate an enclosing rectangle including all the patterns belonging to the same group; and
generate the cutting data in which the respective patterns are arranged in a manner that the enclosing rectangles of the respective groups do not overlap with each other.

12. The non-transitory recording medium according to claim 11,
the instructions further cause, when executed by the controller, the computer to:
generate the cutting data in which the patterns belonging to the other group are arranged outside a range obtained by enlarging the calculated enclosing rectangle by a predetermined distance.

13. The non-transitory recording medium according to claim 11,
the instructions further cause, when executed by the controller, the computer to:
generate, when the number of classified groups is four or less, the cutting data in which the respective patterns are arranged by aligning corners of the enclosing rectangle for the respective groups with each of four corners of a rectangular allowable cutting range determined by the holding member.

14. The non-transitory recording medium according to claim 11, wherein the holding member comprising squares arranged at a predetermined interval, and
the instructions further cause, when executed by the controller, the computer to:
generate the cutting data in which the respective patterns are arranged by aligning the corners of the enclosing rectangle with corners of the squares.

15. The non-transitory recording medium according to claim 11,
the instructions further cause, when executed by the controller, the computer to:
notify a size of the object to be cut determined by the enclosing rectangle and a position at which the object to be cut is to be arranged on the holding member.

16. The non-transitory recording medium according to claim 9,
the instructions further cause, when executed by the controller, the computer to:
acquire color information representing a color of the pattern as the attribute information.
